(19) United States
(12) Patent Application Publication
(10) Pub. No.: US 2025/0282091 A1
(43) Pub. Date: Sep. 11, 2025

(54) ADDITIVE MANUFACTURING METHOD WITH BIOBASED POLYAMIDE COMPOSITION HAVING HIGH THERMAL STABILITY

(71) Applicant: SOLVAY SPECIALTY POLYMERS USA, LLC, Alpharetta, GA (US)

(72) Inventors: Franck Touraud, Saint-Fons (FR); Clement Servel, Saint-Fons (FR); Stéphane Jeol, Saint-Fons (FR); Véronique Bossennec, Saint-Fons (FR)

(73) Assignee: SOLVAY SPECIALTY POLYMERS USA, LLC, Alpharetta, GA (US)

(21) Appl. No.: 18/858,648

(22) PCT Filed: Apr. 21, 2023
(86) PCT No.: PCT/EP2023/060475

§ 371 Date: Oct. 21, 2024

(30) Foreign Application Priority Data
Apr. 21, 2022 (EP) 22305588.0

(51) Int. Cl. B29C 64/118; B29K 77/00; B29K 105/12; B33Y 10/00; B33Y 70/10; C08G 69/08; C09D 7/40; C09D 7/61; C09D 177/02; D01F 6/60

(52) U.S. Cl. CPC B29C 64/118; B33Y 10/00; B33Y 70/10; C08G 69/08; C09D 7/61; C09D 7/70; C09D 177/02; D01F 6/60; B29K 2077/00; B29K 2105/12; B29K 2995/0096

(57) ABSTRACT

Described herein is an additive manufacturing method of making a three-dimensional (3D) object with a polyamide composition comprising at least 50% by weight (wt %) of a polyamide comprising at least 50% by mol (mol %) recurring units of —NH—(CH₂)₈—C(O)— and/or —NH—(CH₂)₉—C(O)—; from 0 wt % to 50 wt % of at least one reinforcing agent and from 0 wt % to 30 wt % of at least one additive, with excellent thermal stability. The present invention also relates to an article or composite material manufactured by the additive manufacturing method.

This application claims priority of European patent application No. 22305588.0 filed on 21 Apr. 2022, the content of which being entirely incorporated herein by reference for all purposes. In case of any incoherency between the two applications that would affect the clarity of a term or expression, it should be made reference to the present application only.

### TECHNICAL FIELD

The present invention relates to an additive manufacturing method of making a three-dimensional (3D) object with a polyamide composition (PC) in the form of a filament and comprising at least 50.0% by weight (wt %) of at least one polyamide (PA) comprising at least 90.0 mol % of recurring units R_{(PA1)} of formula —NH—(CH₂)₈—C(O)— and/or —NH—(CH₂)₉—C(O)—; from 0 wt % to 50.0 wt % of at least one reinforcing agent and from 0 wt % to 30.0 wt % of at least one additive, with excellent thermal stability. This invention is further defined below.

### BACKGROUND

A polyamide is one of the polymers which have been frequently used as engineering plastics for a very wide range of applications. A polyamide composition is of significant commercial interest and may be used to produce automobile or electrical components, generally by injection molding, in view of weight reduction, ease in assembling parts/components and also its design flexibility.

Additive manufacturing systems are used to print or otherwise build 3D parts from digital representations of the 3D parts using one or more additive manufacturing techniques. The digital representation of the 3D part is initially sliced into multiple horizontal layers. For each sliced layer, a tool path is then generated, which provides instructions for the particular additive manufacturing system to print the given layer.

For instance, in an extrusion-based additive manufacturing system, a 3D part may be printed from a digital representation of the 3D part in a layer-by-layer manner by extruding a flowable part material. The part material is extruded through an extrusion tip carried by a print head of the system and is deposited as a consequence of roads on a plate in an x-y plane. The extruded part material fuses to previously deposited part material and solidifies upon a drop in temperature. The position of the print head relative to the substrate is then incremented along a z-axis perpendicular to the x-y plane and the process is then repeated to from a 3D part resembling the digital representation. An example of extrusion-based additive manufacturing system starting from filaments is called Fused Filament Fabrication (FFF) or Fused Deposition Modelling (FDM).

Today, polyamide 6 (PA6), polyamide 11 (PA11) and polyamide 12 (PA12), especially PA12 have been almost exclusively used as optimal polyamides for the additive manufacturing. Notably, PA11 and PA12 have good overall performance thanks to their hydrophobic features together with good mechanical properties comparable to those of polyamide 6 (PA6) or polyamide 66 (PA66). Further, the low density of PA12, i.e. about 1.01 g/mL, which results from its relatively long hydrocarbon chain, confers it good dimensional stability, similar to PA11. However, PA11 and PA12 have limited thermal stability due to the relatively low melting points (about 190° C. for PA11 and about 180° C. for PA12). On the other hand, PA6 has good thermal stability thanks to its high melting point (about 223° C.), but has drawback of high hydrophilicity.

US 2020/0407882 (BASF SE) discloses a fused filament fabrication (FFF) process by using a filament comprising a core material comprising a fibrous filler and a thermoplastic polymer, wherein the core material is coated with a layer of shell material comprising another thermoplastic polymer and the thermoplastic polymer of the core material can be a polyamide, such as PA6, PA46, PA66, PA610, PA6T, PA9T, etc. Said shell material of the filament functions as an adhesive between the layers of the 3D body, which exhibits an increased mechanical strength and accordingly a higher dimensional stability.

U.S. Pat. No. 11,168,227 B2 (D1) discloses a method for forming a 3D object by fused filament fabrication comprising the step of selectively dispensing a polyamide composition containing a semi-crystalline copolyamide, comprising: a) at least 70 wt. % of aliphatic monomeric units derived from i. aminoacid A, or ii. diamine B and diacid C, and b) at least 0.5 wt. % of further monomeric units derived from a cyclic monomer. The aminoacid A may be aminodecanoic acid, aminoundecanoic acid and aminododecanoic acid. D1 does not disclose a proportion of recurring units (R_{PA1}) of at least 90.0 mol %. Moreover, the polyamide (PA) used in the invention is different in that it does not comprise units derived from a cyclic monomer.

WO 2022/043345 (D2) discloses a filament for 3D printing, comprising (A) at least one semicrystalline polyamide which is selected from the group consisting of PA 4, PA 6, PA 7, PA 8, PA 9, PA 11, PA 12, PA 46, PA 66, PA 69, PA6.10, PA6.12, PA6.13, PA6/6.36, PA6T/6, PA 12.12, PA 13.13, PA6T, PA MXD6, PA 6/66, PA 6/12 and copolyamides thereof; (B) at least one amorphous polyamide which is selected from the group consisting of PA 6I/6T, PA 61 and PA 6/3T. The polyamide composition of the filament used in the invention is different.

US 2019/0160737 (WO 2018/019728) discloses a process for producing a shaped body by selective laser sintering with a sinter powder comprising a blend of polyamides.

### Technical Problem

Some applications require to prepare 3D objects made in a material exhibiting hydrophobic features and thermal stability with a melting point exceeding 200° C. Moreover, there is a growing request for materials prepared from renewable feedstocks i.e. bio-based or recycled materials.

The invention aims at solving this technical problem.

### SUMMARY

The invention is as disclosed in the appended set of claims.

The invention relates to an additive manufacturing method as defined in any one of claims 1-28.

The invention also relates to a filament for use in 3D printing as defined in any one of claims 29-44.

The invention also relates to a spool of filament as defined in claim 45.

The invention also relates to a use as defined in claim 46 or in claim 47.

The invention also relates to an article as defined in claims 48 or 49.

More precisions on these subject-matters are provided herein.

### BRIEF DESCRIPTION OF THE DRAWINGS

FIG. 1 represents water uptake (in wt %) at room temperature and relative humidity (RH)=100% of PA9 and PA12.

### DETAILED DESCRIPTION OF THE INVENTION

### Definitions

wt %: % by weight; mol %: % by moles.

The proportions of recurring units in the polyamide (PA) are given relative to the total moles of recurring units in the polyamide (PA).

Throughout this specification, unless the context requires otherwise, the word ‘comprise’ or ‘include’, or variations such as ‘comprises’, ‘comprising’, ‘includes’, ‘including’ will be understood to imply the inclusion of a stated element or method step or group of elements or method steps, but not the exclusion of any other element or method step or group of elements or method steps. The term ‘comprising’ includes ‘consisting essentially of’ and also ‘consisting of’. According to preferred embodiments, the word ‘comprise’ and ‘include’ and their variations mean ‘consist exclusively of’.

The term ‘between’ should be understood as being inclusive of the limits.

As used herein, the term ‘alkyl group’ denotes a radical derived from an alkane by removal of one hydrogen atom and includes saturated hydrocarbons having one or more carbon atoms, including straight and branched chains. As used herein, the them ‘alkylene’ groups denotes a divalent radical derived from an alkane by removal of an hydrogen atom from two carbon atoms.

As used herein, the terminology ‘(Cₙ-Cₘ)’ in reference to an organic group, wherein n and m are integers, respectively, indicates that the group may contain from n carbon atoms to m carbon atoms per group.

In the context of the present invention, the term ‘percent by weight’ (wt %) indicates the content of a specific component in a mixture, calculated as the ratio between the weight of the component and the total weight of the mixture. As used herein, the concentration of recurring units in ‘percent by mol’ (mol %) refers to the concentration relative to the total number of recurring units in the polyamide, unless explicitly stated otherwise.

As used herein, a ‘semi-crystalline’ polyamide comprises a heat of fusion Hm of at least 5.0 Joules per gram (J/g) measured by differential scanning calorimetry (DSC) at a heating rate of 20° C./min. Similarly, as used herein, an “amorphous” polyamide comprises a heat of fusion Hm of less than 5.0 J/g, preferably of less than 3.0 J/g, and more preferably of less than 2.0 J/g measured using DSC at a heating rate of 20° C./min. The heat of fusion Hm can be measured according to ASTM D3418.

As used herein, when referring to ‘glass transition temperature’ (T_{g}) and ‘melting temperature’ (Tₘ) for the polyamide, T_{g} and Tₘ are preferably measured according to ASTM D3418, unless stated otherwise.

In the passages of the present specification which will follow, any description, even though described in relation to a specific embodiment, is applicable to and interchangeable with other embodiments of the present disclosure. Each embodiment thus defined may be combined with another embodiment, unless otherwise indicated or clearly incompatible. In addition, it should be understood that the elements and/or the characteristics of a composition, a product or article, a process or a use, described in the present specification, may be combined in all possible ways with the other elements and/or characteristics of the composition, product or article, process or use, explicitly or implicitly, this being done without departing from the scope of the present description.

### Additive Manufacturing Method

The present invention relates first to an additive manufacturing method.

According to an embodiment, the method of making a three-dimensional (3D) object with a 3D printer comprises the following steps:
a filament comprising or consisting of a polyamide composition (PC) is moved to a print head with an extrusion nozzle;
the polyamide composition (PC) in the molten form is deposited by the extrusion nozzle with a first layer on a substrate to form the beginning of a growing shaped object and with further layers on the growing shaped object, the layers being formed according to a predetermined sequence and pattern;
once the 3D object is prepared and has cooled, it is detached from the substrate,
   the polyamide composition (PC) consisting of:
at least 50.0% wt % of at least one polyamide (PA) comprising at least 90.0 mol % of recurring unit R_{(PA1)} according to formula (V):

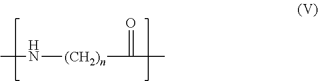

from 0 wt % to 50 wt % of at least one reinforcing agent; and
from 0 wt % to 30 wt % of at least one additive;
   wherein
n is 8 or 9;
wt % is relative to the total weight of the polyamide composition; and
mol % is relative to the total moles of recurring units in the polyamide (PA).

According to another embodiment, the method of making a three-dimensional (3D) object comprises the steps of:
feeding an additive manufacturing filament comprising or consisting of a polyamide composition (PC) to a discharge head member of a 3D printer, the discharge member having a through-bore ending with a discharge tip and a circumferential heater to melt the filament in the through-bore;
heating the filament within the discharge member while applying pressure to cause the discharge of the heated filament through the discharge tip onto a receiving platform or support structure; and
moving the discharge tip in X-, Y- and/or Z-direction(s) while the heated filament is being discharged to form the 3D object,
   the polyamide composition (PC) consisting of:
at least 50.0% wt % of at least one polyamide (PA) comprising at least 90.0 mol % of recurring unit R_{(PA1)} according to formula (V):

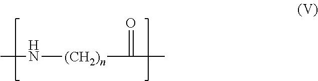

from 0 wt % to 50 wt % of at least one reinforcing agent; and
from 0 wt % to 30 wt % of at least one additive;
   wherein
n is 8 or 9;
wt % is relative to the total weight of the polyamide composition; and
mol % is relative to the total moles of recurring units in the polyamide (PA).

In one embodiment, the step of heating the filament is performed at a temperature of at least 210° C., prior to extrusion.

In a particular embodiment, the additive manufacturing method further comprises a step of compressing the filament with a piston, in advance of moving the discharge tip.

In a more particular embodiment, during the compressing step, the unmelt filament acts as a piston in the through-bore.

Additionally, the 3D printer may comprise a chamber in order to maintain the filament as determined at a specific temperature, notably between 6° and 180° C., preferably between 8° and 160° C.

The 3D object may also be subjected to heat-treatment after manufacture (also called annealing or tempering). In this case, the 3D object may be placed in an oven set up at a temperature ranging from 60 to 180° C., preferably from 80 to 160° C., for a period of time of ranging from about 30 minutes to 24 hours, preferably from 1 hour to 8 hours.

The additive manufacturing method of the present invention is preferably a Fused Filament Fabrication (FFF) method, also known as Fused Deposition Modelling (FDM). FFF/FDM 3D printers are, for example, commercially available from Apium, from Roboze, from Hyrel or from Stratasys, Inc. (under the trade name of Fortus®).

In these methods of making 3D objects by additive manufacturing also called 3D printing, the articles are printed from the polyamide composition (PC). The methods include printing layers of the articles and/or composite materials from the polyamide composition (PC) as described herein.

The 3D object is generally built on a substrate, which is generally a horizontal substrate and/or on a planar substrate. The substrate may be moveable in all directions, for example in the horizontal or vertical direction. During the 3D printing process, the substrate can, for example, be lowered, in order for the successive layer of polymeric material to be deposited on top of the former layer of polymeric material.

In some embodiments, the additive manufacturing method of the invention for making a 3D object further comprises a step consisting in producing a support structure, using a support material. According to such embodiments, the 3D object is built upon the support structure and both the support structure and the 3D object are produced using the same additive manufacturing method. The support structure may be useful in multiple situations. For example, the support structure may be useful in providing sufficient support to the printed or under-printing in order to avoid distortion of the shaped 3D object, especially when this 3D object is not planar. This is particularly true when the temperature used to maintain the printed or under-printing 3D object is below the re-solidification temperature of the polyamide. A variety of conventional polymers can be used as a breakaway or soluble support material. Any support material used in conjunction with PA6 or PA12 filaments can be used in conjunction with the filament of the invention. A non-exhaustive list of soluble support materials are polyvinylalcohol and polyglycolic acid. The support material may also possess a water absorption behaviour or a solubility in water at a temperature lower than 110° C., in order to sufficiently swell or deform upon exposure to moisture.

In one embodiment, the additive manufacturing method for making a 3D object, further comprises the steps of:
printing layers of a support structure from a support material, for example extruding a filament of support material, before the step of extrusion of the filament; and
removing at least a portion of the support structure from the 3D object, after 3D printing.

### 3D Objects and Articles Prepared by the Method

The present invention relates fourthly to an article.

The 3D object prepared with the method of the invention can be an automotive component, a LED packaging, an electrical and electronic component (including, but not limited to, power unit components for computing, data-system and office equipment and surface mounted technology compatible connectors and contacts), a medical device component.

### About the Filament

The present invention relates second to an a filament.

Details will now be given about the filament of the invention or used in the method of the invention.

The filament has a cylindrical or substantially cylindrical geometry.

The filament may have a cylindrical or substantially cylindrical geometry with a diameter d between 0.5 mm and 5.0 mm. d may vary between 0.8 and 4.0 mm or between 1.0 mm and 3.5 mm.

The filament may have a cylindrical geometry and a diameter d of at least 0.5 mm, preferably at least 1.3 mm, more preferably at least 1.4 mm, most preferably at least 1.5 mm, and/or of at most 5.0 mm, preferably at most 3.5 mm, more preferably at most 3.25 mm, most preferably at most 3 mm.

d can be chosen to feed a specific FFF 3D printer. An example of diameter used extensively in FFF process has a diameter d of 1.75 mm or 2.85 mm.

Preferentially, the filament has a round cross-section.

The length L of the filament is generally at least 200 mm.

The filament may be in the form of a spool. The invention thus also relates to a spool of the filament. The spool is made of or comprises the polyamide composition (PC).

Preferably, the filament is a full filament. The term “full” is used in comparison to a hollow geometry and denotes a filament which is not hollow.

According to a preferred embodiment, the filament does not present a core/shell geometry with another polymeric composition. The “core shell geometry” refers to a filament having an elongated core radially surrounded by an outer shell. The core and the shell are generally made of two different polyamide compositions or of two polymers of the same composition but with distinct physico-chemical properties.

The core/shell geometry requires the use of a more complex coextrusion system for its preparation than a simple extrusion system. Moreover, during the 3D printing process, the material(s) of the shell are mixed with the material(s) of the core and this results in several anticipated technical difficulties (inhomogeneity of the composition of the 3D object, contamination with the material(s) of the shell, etc).

To avoid the inhomogeneity described above, the components of the composition (PC) are preferably blended together. The term “blend” is intended to denote a homogeneous (or uniform) physical mixture. The term “blended” is intended to mean that the components, notably of the polyamide composition (PC), form an homogeneous (or uniform) physical mixture.

Preferably, the composition of the filament consists of the polyamide composition (PC). In other words, the filament is constituted or consists of the polyamide composition (PC).

### About the Polyamide Composition (PC)

The polyamide composition (PC) consists of:
at least 50.0% by weight (wt %) of at least one polyamide (PA);
from 0 wt % to 50.0 wt % of at least one reinforcing agent; and
from 0 wt % to 30.0 wt % of at least one additive.

These proportions in wt % are given relative to the total weight of the polyamide composition (PC).

The polyamide composition (PC) comprises at least one polyamide (PA) as defined herein. It may comprise only one or more than one polyamide (PA).

The components of the polyamide composition (PC) are preferably blended together.

Details about the reinforcing agent(s) and the additive(s)—both optional as their respective proportion may independently be 0%—will now be provided.

The total proportion of the reinforcing agent(s) is between 0 and 50.0 wt %. The total proportion of the additive(s) different from the reinforcing agent is between 0 and 30.0 wt %.

### Reinforcing Agent

The polyamide composition (PC) comprises at least one reinforcing filler, in an amount of from 0 wt % to 50.0 wt % relative to the total weight of polyamide composition.

The term ‘reinforcing agent’ is intended to denote a material added to a polyamide composition to improve its mechanical properties, such as rigidity, tensile strength, impact resistance and dimensional stability and/or to reduce the cost. By appropriately selecting these materials, not only the economics but also other properties such as processing and mechanical behavior can be improved. Although those reinforcing agents retain their inherent characteristics, very significant differences are often observed depending on the molecular weight, compounding technique and the presence of other additives in the formulation. Therefore, once the basic property requirements are established, the optimum type and loading level of reinforcing agent for the balance between cost and performance must be determined.

The polyamide composition (PC) comprises from 0 wt % to 50.0 wt % of at least one reinforcing agent, relative to the total weight of polyamide composition (PC).

The proportion of reinforcing agent(s) may be at least 0.1 wt %, preferably at least 1.0 wt %, preferably at least 5.0 wt %, preferably at least 10.0 wt %, more preferably at least 15.0 wt %. This proportion may be at most 50.0 wt %, preferably at most 45.0 wt %, more preferably at most 40.0 wt %, based upon the total weight of the polyamide composition.

The reinforcing agent may more particularly be selected from the group consisting of mineral fillers (e.g. talc, mica, kaolin, calcium carbonate, calcium silicate, magnesium carbonate), glass fibers, carbon fibers, synthetic polymeric fibers, aramid fibers, aluminum fibers, titanium fibers, magnesium fibers, boron carbide fibers, rock wool fibers, steel fibers, natural fibers (e.g. linen, hemp or cellulose), graphene, nano-graphene, carbon nanotube, wollastonite, glass balls (e.g. hollow glass microspheres) and any combination of two or more thereof.

The reinforcing agent may more particularly be selected from the group consisting of carbon fibers, glass fibers and combinations thereof.

Glass fibers are silica-based glass compounds that contain several metal oxides which can be tailored to create different types of glass. The main oxide is silica in the form of silica sand; the other oxides such as calcium, sodium and aluminum are incorporated to reduce the melting temperature and impede crystallization. The glass fibers may be endless fibers or chopped glass fibers.

In some embodiments, the glass fibers have an average length of from 3 mm to 50 mm. In some such embodiments, the glass fibers have an average length of from 3 mm to 10 mm, from 3 mm to 8 mm, from 3 mm to 6 mm, or from 3 mm to 5 mm. In alternative embodiments, the glass fibers have an average length of from 10 mm to 50 mm, from 10 mm to 45 mm, from 10 mm to 35 mm, from 10 mm to 30 mm, from 10 mm to 25 mm or from 15 mm to 25 mm.

In some embodiments, the glass fibers have generally an equivalent diameter of from 5 to 20 m, preferably of from 5 to 15 m, more preferably of 5 to 10 m.

All glass fiber types, such as A, C, D, E, M, R, S, T glass fibers (as described in chapter 5.2.3, pages 43-48 of Additives for Plastics Handbook, 2nd edition, John Murphy), or any mixtures thereof may be used. E, R, S and T glass fibers are well known in the art. They are notably described in Fiberglass and Glass Technology, Wallenberger, Frederick T.; Bingham, Paul A. (Eds.), 2010, XIV, chapter 5, pages 197-225. R, S and T glass fibers are composed essentially of oxides of silicon, aluminium and magnesium. In particular, those glass fibers comprise typically from 62 to 75 wt % of SiO₂, from 16 to 28 wt % of Al₂O₃ and from 5 to 14 wt % of MgO. On the other hand, R, S and T glass fibers comprise less than 10 wt % of CaO.

The polyamide composition (PC) may further comprise at least one reinforcing agent which is different than the glass fibers and/or carbon fibers, as described above. A large selection of reinforcing agents, also called reinforcing fibers or fillers, may be added to the polyamide composition (PC). They can be selected from fibrous and particulate reinforcing agents.

A fibrous reinforcing filler is considered herein to be a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50. In some embodiments, the reinforcing fibers (e.g. carbon fibers) have an average length of from 3 mm to 50 mm. In alternative embodiments, the reinforcing fibers have an average length of from 10 mm to 50 mm. The average length of the reinforcing fibers can be taken as the average length of the reinforcing fibers prior to incorporation into the polyamide composition or can be taken as the average length of the reinforcing fiber in the polyamide composition.

A particulate reinforcing agent may be selected from mineral fillers (such as talc, mica, kaolin, calcium carbonate, calcium silicate, magnesium carbonate), graphene, nano-graphene, carbon nanotube, and glass balls (e.g. hollow glass microspheres).

In a particular embodiment, the polyamide composition (PC) includes nano-graphene and/or carbon nanotube as a reinforcing agent.

In another particular embodiment, the polyamide composition (PC) includes at most 3 wt % of nano-graphene and/or carbon nanotube based upon the total weight of the polyamide composition (PC) in addition to the glass fibers and/or carbon fibers as reinforcing agents.

In some embodiments, the polyamide composition (PC) excludes a reinforcing agent which is different from the glass fiber, as described above.

In some embodiments, the polyamide composition (PC) excludes glass spheres or balls and in particular excludes hollow glass balls.

In a particular embodiment, the polyamide composition (PC) comprises at least one non-metallic reinforcing agent. In another embodiment, the reinforcing agent is non-metallic.

In a more particular embodiment, the non-metallic reinforcing agent is selected from the group consisting of mineral fillers, glass fibers, carbon fibers, synthetic polymeric fibers, aramid fibers, aluminum fibers, titanium fibers, magnesium fibers, boron carbide fibers, rock wool fibers, steel fibers, natural fibers, graphene, nano-graphene, carbon nanotube, wollastonite and any combination of two or more thereof, preferably carbon fibers and/or glass fibers.

### Additive(s)

The polyamide composition (PC) comprises at least one additive, which is different from the reinforcing agent, in an amount of from 0 wt % to 30.0 wt % relative to the total weight of polyamide composition.

The additive may more particularly be selected from the group consisting of lubricants such as linear low density polyethylene, calcium stearate, magnesium stearate or sodium montanate; plasticizers; flame retardants, such as halogen and halogen-free flame retardants; nucleating agents; heat stabilizers; light stabilizers; antioxidants; processing aids; fusing agents; electromagnetic absorbers; tougheners; antistatic agents; impact modifiers; anti-blocking additive; slip additives; antifogging additives; chemical blowing agents, and any combinations thereof.

In a particular embodiment, the additive is selected from the group consisting of colorants, dyes, pigments, lubricants, plasticizers, flame retardants, nucleating agents, heat stabilizers, light stabilizers, antioxidants, processing aids, fusing agents, electromagnetic absorbers and any combinations thereof.

In a particular embodiment, the additive is selected from the group consisting of colorants, dyes, pigments, lubricants, plasticizers, nucleating agents, heat stabilizers, light stabilizers, antioxidants, processing aids, fusing agents, electromagnetic absorbers and any combinations thereof.

In a preferred embodiment, the additive is comprised in an amount of at least 0.1 wt %, preferably at least 0.2 wt %, more preferably at least 0.4 wt %, most preferably at least 0.5 wt %, and/or of at most 30 wt %, preferably at most 25 wt %, more preferably at most 15 wt %, most preferably at most 10 wt %, based upon the total weight of the polyamide composition.

In a particular embodiment, the additive is comprised in an amount of from 0.1 wt % to 5 wt %, preferably from 0.2 wt % to 3 wt %, more preferably from 0.4 wt % to 2 wt %, most preferably 0.5 wt % to 1 wt %, based upon the total weight of the polyamide composition (PC).

### Preparation of the Polyamide Composition (PC)

The polyamide composition (PC) is prepared by mixing the components of the composition (PC), the polyamide (PA) and the mixture to be mixed being in the molten form.

Any melt-mixing apparatus may be used for this preparation. Suitable melt-mixing apparatus are, for example, kneaders, Banbury mixers, single-screw extruders and twin-screw extruders. These apparatus make it possible to obtain an homogeneous polyamide composition (PC)

Preferably, use is made of an extruder, notably fitted with means for dosing all the desired components to the extruder, either to the extruder's throat or to the melt.

The order of combining the components during melt-mixing is not particularly limited. In one embodiment, the components can be mixed in a single batch, such that the desired amounts of each of them are added together and subsequently mixed. In other embodiments, a first sub-set of components can be initially mixed together and one or more of the remaining components can be added to the mixture for further mixing.

### Preparation of the Filament

The filament of the present invention can be prepared from a two-step process in which a compound is first produced to make pellets of the polyamide composition (PC), and then these pellets are extruded to produce the filament.

Alternatively, the filament can be prepared from an integrated process in which the polyamide composition (PC) and the filament are prepared in a one-step process.

In both cases, the extrusion is performed with the polyamide composition (PC) being in the molten form. The polyamide composition (PC) thus needs to be heated at a temperature T which is above the melting temperature (Tm) of the polyamide (PA). T may be above Tm+10° C., preferably Tm+20° C.

The diameter d and the geometry of the filament is controlled by selecting the appropriate die.

The method for manufacturing the filaments also comprises a step of extrusion, for example with a die. For this purpose, any standard extrusion technique can be used. Standard techniques including shaping the polyamide composition (PC) in a molten form can be advantageously applied. Dies may be used to shape the articles, for example a die having a circular orifice if the article is a filament of cylindrical geometry.

The process per se or each step of the process, if relevant, may also comprise a step consisting in a cooling of the molten mixture.

Once the filament is formed, it may be rolled in the form of a spool.

### About the Polyamide (PA)

The polyamide (PA) comprises at least 90.0 mol % of recurring units R_{(PA1)} according to formula (V):

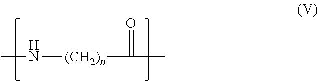

where n is 8 or 9.

According an embodiment, n is 8. According to another embodiment, n is 9.

The proportion of recurring units R_{(PA1)} is preferably at least 95.0 mol %, preferably at least 99.0 mol %, preferably at least 99.5 mol %, even preferably at least 99.9 mol %.

The proportion of recurring units R_{(PA1)} is most preferably 100 mol %.

In some embodiments, the polyamide (PA) further comprises at least 0.1 mol % of recurring units R_{(PA2)} and/or R_{(PA3)} according to formulae (VI) and (VII), respectively:

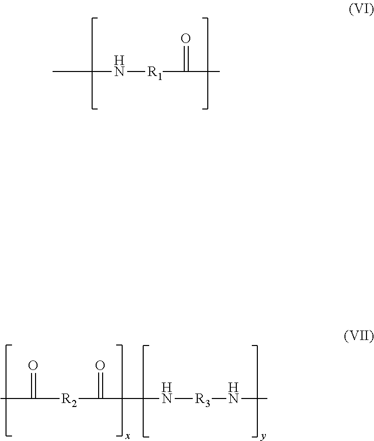

wherein:
R₁ is selected a C₂-C₁₈ alkylene group;
R₂ is selected from the group consisting of a C₂-C₁₈ alkylene group;
R₃ is selected from the group consisting of a C₄-C₁₈ alkylene group;
x and y are 0 or 1, respectively; and
the recurring unit R_{(PA2)} of formula (VI) is different from the recurring unit R_{(PA1)} of formula (V).

The alkylene groups in R₁, R₂ and R₃ are preferably of formula —(CH₂)ⱼ— where j is an integer respectively between 2 and 18; 2 and 18 or 4 and 18.

In one embodiment, x is zero and y is 1 such that recurring units R_{(PA3)} are recurring units of formula (VII-1):

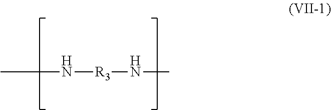

In another embodiment, x is 1 and y is zero such that recurring units R_{(PA3)} are recurring units of formula (VII-2):

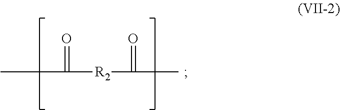

In a particular embodiment, the polyamide (PA) comprises at least 1.0 mol % of recurring units R_{(PA2)} and/or R_{(PA3)} according to formulae (VI) and (VII), respectively.

In another particular embodiment, the polyamide (PA) further comprises at least 3.0 mol % of recurring units R_{(PA2)} and/or R_{(PA3)} according to formulae (VI) and (VII), respectively.

In the present invention, the polyamide (PA) may comprise additional recurring units, distinct from recurring units (R_{PA2}) and (R_{PA3}). Yet, the polyamide (PA) preferably does not comprise recurring units derived from a cyclic monomer. A cyclic monomer denotes a monomer which includes a cyclic unit and is not a lactam. A cyclic monomer which is not a lactam leads to recurring units in the resulting polyamide that include a cyclic unit. The cyclic monomer is generally an aromatic or a cycloaliphatic monomer. Examples of cyclic monomers are now provided: isophoronediamine (IPD), cis-1,4-diaminocyclohexane, trans-1,4-diaminocyclohexane, bis-(p-aminocyclohexane)methane (PACM), 2,2-Di-(4-aminocyclohexyl)-propane, 3,3′-dimethyl-4-4′-diaminodicyclohexylmethane (DMDC), p-xylylenediamine, m-xylylenediamine, 3,6-bis(aminomethyl)norbornane, isophthalic acid (I), terephthalic acid (T), 4-methylisophthalic acid, 4-tert-butylisophthalic acid, 1,4-naphthalenedicarboxylic acid and 2,6-naphthalenedicarboxylic acid, cis-1,4-cyclohexanedicarboxylic acid, trans-1,4-cyclohexanedicarboxylic acid, cis-1,3-cyclohexanedicarboxylic acid and trans-1,3-cyclohexanedicarboxylic acid.

The recurring units of the polyamide (PA) preferably consist of recurring units R_{(PA1)} and optionally of recurring units R_{(PA2)} and/or R_{(PA3)}. Most preferably, the recurring units of the polyamide (PA) consist preferably of recurring units R_{(PA1)}.

### Properties of the Polyamide (PA)

The polyamide (PA) has a number average molecular weight Mn (in g/mol) of at least 12,000, at least 13,000, at least 14,000, or at least 14,500. Mn is preferably at most 20,000 g/mol, preferably at most 18,000 g/mol. Depending on the molecular weight, the mechanical properties of a polyamide, e.g. tensile properties such as elongation at break substantially differ. For instance, in case the molecular weight is below 10,000, the elongation at break and also the melt viscosity would be too low to apply the polyamide in preparing an article or composite material by additive manufacturing. In addition, low melt viscosity of a polyamide may become a big obstacle in making a circular filament with a diameter of interest to be used in additive manufacturing.

Mn can be determined by Size Exclusion Chromatography (SEC) or preferably with the use of the following equation (1): Mn=2,000,000/[EG](1) wherein [EG] is the proportion of end-groups in the PA expressed in mmol/kg. The proportions of end-groups may be determined by known analytical methods such as potentiometric methods for amine and/or acid end-groups or ¹H NMR for amide end-groups. See eg. Schröder, Elisabeth, Müller, Gert and Arndt, Karl-Friedrich. “1.2. Molecular Weight Determination by End Group Analysis”. Polymer Characterization, Berlin, Boston: De Gruyter, 1989, pp. 18-33 (https://doi.org/10.1515/9783112531846-003).

The polyamide (PA) has a melting point (Tm), as measured according to ASTM D3418, of at least 180° C., preferably at least 185° C., preferably at least 187° C., preferably at least 190° C., more preferably at least 200° C., and/or of at most 290° C., preferably at most 285° C., more preferably at most 280° C. Tm may preferably be between 18° and 230° C.

The polyamide (PA) has a glass transition temperature (Tg), as measured according to ASTM D3418, of at least 20° C., preferably at least 30° C., more preferably at least 40° C., and/or of at most 200° C., preferably at most 190° C., more preferably at most 180° C. Tg may be between 35° C. and 80° C. or between 40° C. and 70° C., preferably between 40° C. and 60° C., more preferably between 40° C. and 50° C.

The polyamide (PA) has a heat of fusion (Hm), as measured according to ASTM D3418, of at least 5.0 J/g, preferably at least 7.0 J/g, more preferably at least 10.0 J/g, and/or of at most 80.0 J/g, preferably at most 70.0 J/g, more preferably at most 60.0 J/g.

In a preferred embodiment, the polyamide (PA) is bio-based. Under this embodiment, the polyamide (PA) exhibits a biobased content of at least 85.0%, the biobased content being expressed as the % of organic carbon of renewable origin in the polyamide (PA) and measured according to ASTM D6866-22. The biobased content is defined as the % of organic carbon of renewable origin. It corresponds to the amount of C calculated from measured ¹⁴C percent in the sample and corrected for isotopic fraction. A polymer having a biobased content of 100% has all its carbon atoms of a renewable origin.

The biobased content of the polyamide (PA) may preferably be at least 90.0%, preferably at least 95.0%. The biobased content of the polyamide (PA) may preferably be between 90.0 and 100% and preferably, it is 100%.

The polyamide (PA) and the polyamide composition generally have a water uptake, as measured by ASTM D570-98, of less than 2% after 24 hours and less than 3% after 60 days immersion at 23° C.

The polyamide (PA) may exhibit one or more of the following properties:
a tensile strength measured according to ISO 527-1, between 40 and 70 MPa, preferably between 50 and 60 MPa; and/or
a tensile modulus measured according to ISO 527-1, between 800 and 1400 MPa, preferably between 1000 and 1200 MPa; and/or
flexural strength measured according to ISO 178, between 50 and 90 MPa, preferably between 60 and 80 MPa; and/or
a flexural modulus measured according to ISO 178, between 1200 and 1900 MPa, preferably between 1300 and 1800 MPa;
a heat deflection measured according to ISO 75 (0.45 MPa) of 100° C. or more.

The polyamide (PA) may notably exhibit all these properties.

The conditions of preparation to prepare the polyamide (PA) exhibiting these properties are given in EP 3872116 (D2).

### End-Groups of the Polyamide (PA)

The end-groups of the polyamide (PA) are selected in the group of —NH₂, —COOH and amide end-groups. Indeed, the end-groups in the polyamide (PA) may be —NH₂ or —COOH. Yet, when the polycondensation involves the addition of an end-capping agent, these end-groups may be converted, partially or totally, into amide end-groups.

The amide end groups are of formula —NH—C(═O)—R where R is an an alkyl group, an aryl group or a cycloalkyl group and/or of formula —C(═O)—NH—R′ where R′ is an alkyl group or a cycloalkyl group. R is more particularly a linear or branched C₂-C₁₈ alkyl group or a C₅-C₁₀ cycloalkyl group. R′ is more particularly a linear or branched C₂-C₁₈ alkyl group.

The amide end groups of formula —NH—C(═O)—R result from the reaction of the end-groups —NH₂ with a monocarboxylic acid (end-capping agent) of formula R—COOH.

The monocarboxylic acid (end-capping agent) may advantageously be selected in the group consisting of benzoic acid; cyclohexanoic acid; R—COOH where R is a linear or branched C₂-C₁₈ alkyl group and combination of two or more of these acids. R is the radical derived from the acid of formula R—COOH.

The monocarboxylic acid (end-capping agent) may more particularly be selected in the group consisting of acetic acid, propanoic acid, butyric acid, valeric acid, caproic acid, lauric acid, stearic acid, 2-ethylhexanoic acid, cyclohexanoic acid, benzoic acid and combination of two or more of these acids.

The monocarboxylic acid (end-capping agent) is more particularly of formula CH₃—(CH₂)ₘ—COOH where m is an integer between 0 and 16. The amide end groups are then of formula —NH—C(═O)—(CH₂)ₘ—CH₃.

The amide end groups of formula —C(═O)—NH—R′ result from the reaction of the end-groups —COOH with a primary amine (end-capping agent) of formula R′—NH₂.

The primary amine (end-capping agent) may advantageously be selected in the group consisting of the amines of formula R′—NH₂ where R′ is a linear or branched C₂-C₁₈ alkyl group. R′ is the radical derived from the amine of formula R′—NH₂.

The primary amine (end-capping agent) is more particularly of formula CH₃—(CH₂)_{m′}—NH₂ where m′ is an integer between 2 and 18. The amide end groups are then of formula —C(═O)—NH—(CH₂)_{m′}—CH₃.

The primary amine (end capping agent) may more particularly be selected in the group consisting of propyl amine, butylamine, pentylamine, hexylamine, 2-ethylhexylamine, n-octylamine, n-dodecylamine, n-tetradecylamine, n-hexadecylamine, stearylamine, cyclohexylamine and combination of two or more of these amines.

The proportion of the end groups can be quantified by ¹H NMR or by potentiometric techniques.

### Preparation of the Polyamide (PA)

The polyamide (PA) is prepared by polycondensation.

The polyamide (PA) is prepared by polycondensation by heating a reaction mixture (RM) comprising:
an amino acid component comprising the amino acid of formula (I): NH₂—(CH₂)ₙ—COOH (I) wherein n is 8 or 9;
optionally a diamine component comprising at least one diamine of formula (III) H₂N—R₂—NH₂ (III) where R₂ is as disclosed herein;
optionally a dicarboxylic acid component comprising at least one dicarboxylic acid of formula (IV) HOOC—R₃—COOH (IV) where R₃ is as disclosed herein;
optionally an amino acid comprising at least one aminoacid NH₂—R₁—COOH (II) different from the aminoacid of formula (I) where R₁ is as disclosed herein.

The reaction mixture (RM) preferably does not comprise a cyclic monomer.

Biobased aminoacid(s) of formula (I) may be used to prepare the polyamide (PA) having a biobased content. Thus, oleic acid, a fatty acid that occurs naturally in various natural resources, may be used as a starting material to produce 9-aminopelargonic acid, i.e. 9-aminononanoic acid. Such bio-based oleic acid undergoes oxidative cleavage to produce pelargonic acid and azelaic acid, of which the latter is subject to nitrilation and then hydrogenation to obtain 9-aminopelargonic acid. Similarly, ricinoleic acid, a fatty acid that occurs naturally in various natural resources, may be used as a starting material to produce 10-aminodecanoic acid. Such bio-based ricinoleic acid can be hydrolyzed with caustic soda to produce 2-octanol or capryl alcohol and sebacic acid. Other routes like oxidative cleavage, ozonolysis, fermentation, etc. of ricinoleic acid yield sebacic acid and various by products. For example, nitrilation of the sebacic acid, followed by hydrogenation delivers 10-aminodecanoic acid. US 2011/0105774 A1 (Arkema France) also discloses a process of preparing 9-aminononanoic acid or its esters from natural unsaturated fatty acids. Biobased 9-aminopelargonic acid and 10-aminodecanoic acid are also available on the market.

The diamine component includes all the diamines in the reaction mixture (RM) that polycondense with the dicarboxylic acid(s) or amino acid(s) in the reaction mixture (RM) to form the recurring units of the polyamide (PA). Similarly, the dicarboxylic acid component includes all the dicarboxylic acids in the reaction mixture (RM) that polycondense with the diamine(s) or amino acid(s) in the reaction mixture. Further, the amino acid component includes all of the amino acids in the reaction mixture (RM) that polycondense with the diamine(s), the dicarboxylic acid(s) or the amino acid(s) in the reaction mixture.

In the reaction mixture (RM), the proportions of diamines, dicarboxylic acids and amino acids are such as to obtain the desired final composition of the polyamide (PA). The initial proportions of acid —COOH and amine groups —NH₂ from the monomers in the reaction mixture (RM) is generally such that the molar ratio [—COOH]/[—NH₂] is from 0.9 to 1.1, preferably from 0.95 to 1.07, more preferably 1.00 to 1.05, where [—COOH]and [—NH₂] are the initial number of moles of —NH₂ and —COOH groups from the monomers in the reaction mixture (RM).

The reaction mixture (RM) also preferably comprises a catalyst, for instance a catalyst containing at least an atom of phosphorus such as sodium hypophosphite or phosphoric acid.

The reaction mixture (RM) must be heated at a high temperature, preferably up to a temperature of at least Tm+10° C., Tm being the melting temperature of the polyamide. The temperature at which the condensation is performed is usually at least 200° C.

The polycondensation is advantageously performed in the melt, notably in the absence of a solvent.

The polycondensation is advantageously performed in a well stirred vessel such as a stirred reactor. The vessel is also advantageously equipped with means to remove the volatile products of reaction. One can conveniently use a stirred vessel to perform the polycondensation.

The conditions disclosed in the experimental section for the preparation of PA9 may be followed and adapted to the composition of polyamide (PA). The experimental conditions disclosed in examples 1 or 2 of EP 3872116 A1 may also be followed and adapted to the composition of polyamide (PA).

Non-limitative examples of suitable amino acids of formula (I) are notably 6-amino-hexanoic acid, 11-aminoundecanoic acid and 12-aminododecanoic acid.

Non-limitative examples of dicarboxylic acids of formula (IV) are notably malonic acid, succinic acid, glutaric acid, 2,2-dimethyl-glutaric acid, adipic acid, 2,4,4-trimethyl adipic acid, pimelic acid, suberic acid, sebacic acid, undecanedioic acid and dodecandioic acid.

Non-limitative examples of diamines of formula (III) are notably 1,2-diaminoethane, 1,2-diaminopropane, propylene-1,3-diamine, 1,3-diaminobutane, 1,4-diaminobutane, 1,5-diaminopentane, 1,5-diamino-2-methylpentane, 1,4-diamino-1,1-dimethylbutane, 1,4-diamino-1-ethylbutane, 1,4-diamino-1,2-dmethylbutane, 1,4-diamino-1,3-dimethylbutane, 1,4-diamino-1,4-dimethylbutane, 1,4-diamino-2,3-dimethylbutane, 1,2-diamino-1-buthylethane, 1,6-diaminohexane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2dimethylheptane, 1,10-diaminodecane, 1,8-diamino-1,3-imethyloctane, 1,8-diamino-1,4-dimethyloctane, 1,8-diamino-2,4-dimethyloctane, 1,8-diamino-3,4-dimethyloctane, 1,8-diamino-4,5-dimethyloctane, 1,8-diamino-2,2-dimethyloctane, 1,8-diamino-3,3-dimethyloctane, 1,8-diamino-4,4-dimethyloctane, 1,6-diamino-2,4-diethylhexane, 1,9-diamino-5-methylnonane, 1,11-diaminoundecane, 1,12-diaminododecane and 1,13-diaminotridecane.

### End-Groups of the Polyamide (PA)

The end-groups of the polyamide (PA) are selected in the group of —NH₂, —COOH and amide end-groups. Indeed, the end-groups in the polyamide (PA) may be —NH₂ or —COOH. Yet, when the polycondensation involves the addition of an end-capping agent, these end-groups may be converted, partially or totally, into amide end-groups.

The amide end groups are of formula —NH—C(═O)—R where R is an an alkyl group, an aryl group or a cycloalkyl group and/or of formula —C(═O)—NH—R′ where R′ is an alkyl group or a cycloalkyl group. R is more particularly a linear or branched C₂-C₁₈ alkyl group or a C₅-C₁₀ cycloalkyl group. R′ is more particularly a linear or branched C₂-C₁₈ alkyl group.

The amide end groups of formula —NH—C(═O)—R result from the reaction of the end-groups —NH₂ with a monocarboxylic acid (end-capping agent) of formula R—COOH.

The monocarboxylic acid (end-capping agent) may advantageously be selected in the group consisting of benzoic acid; cyclohexanoic acid; R—COOH where R is a linear or branched C₂-C₁₈ alkyl group and combination of two or more of these acids. R is the radical derived from the acid of formula R—COOH.

The monocarboxylic acid (end-capping agent) may more particularly be selected in the group consisting of acetic acid, propanoic acid, butyric acid, valeric acid, caproic acid, lauric acid, stearic acid, 2-ethylhexanoic acid, cyclohexanoic acid, benzoic acid and combination of two or more of these acids.

The monocarboxylic acid (end-capping agent) is more particularly of formula CH₃—(CH₂)ₘ—COOH where m is an integer between 0 and 16. The amide end groups are then of formula —NH—C(═O)—(CH₂)ₘ—CH₃.

The amide end groups of formula —C(═O)—NH—R′ result from the reaction of the end-groups —COOH with a primary amine (end-capping agent) of formula R′—NH₂.

The primary amine (end-capping agent) may advantageously be selected in the group consisting of the amines of formula R′—NH₂ where R′ is a linear or branched C₂-C₁₈ alkyl group. R′ is the radical derived from the amine of formula R′—NH₂.

The primary amine (end-capping agent) is more particularly of formula CH₃—(CH₂)_{m′}—NH₂ where m′ is an integer between 2 and 18. The amide end groups are then of formula —C(═O)—NH—(CH₂)_{m′}—CH₃.

The primary amine (end capping agent) may more particularly be selected in the group consisting of propyl amine, butylamine, pentylamine, hexylamine, 2-ethylhexylamine, n-octylamine, n-dodecylamine, n-tetradecylamine, n-hexadecylamine, stearylamine, cyclohexylamine and combination of two or more of these amines.

The proportion of the end groups can be quantified by ¹H NMR or by potentiometric techniques.

### EXPERIMENTAL SECTION

### Raw Materials

9-aminopelargonic acid (or 9-aminononanoic acid) is of formula:

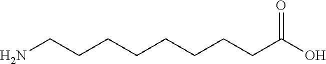 [SMILES: NCCCCCCCCC(=O)O]

PA12: commercially available from Evonik (Vestamid® L1700)

### Preparation of PA9

A stirred batch vessel was charged with the following reaction mixture (RM): 2,425 g of 9-aminopelargonic acid (19.3 mol) and 0.736 g of sodium hypophosphite (7 mmol). The reaction mixture was heated to 230° C. and kept at this temperature for 45 min. During this phase, 221 g of water was distilled out. The pressure was then reduced to 600 mbar and held in these conditions for 120 min. 55 g of water was recovered. The reactor was brought back to atmospheric pressure and the polyamide was downloaded and pelletized. 1,505 g of PA9 was recovered. Melt polycondensation of the 9-amino nonanoic acid in an autoclave yielded the PA9 with a molecular weight of 15,300 g/mol.

### Test Methods & RESULTS

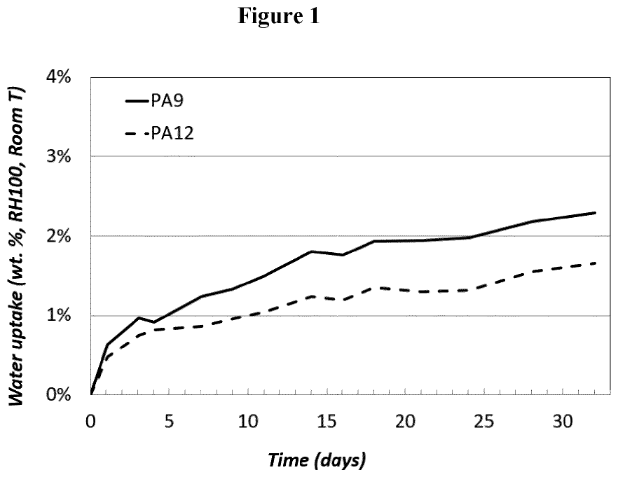

Melting point (Tₘ) (ASTM D3418): Tₘ of PA9 and PA12 were measured as 209° C. and 180° C. respectively. Tₘ of PA11 was reported as about 190° C. in the literature (Polymers 2021, Vol. 13, 2139).
Water Uptake (ASTM D570-98): PA9 and PA12 were soaked in water (100% RH) at room temperature (23° C.) and their weight was measured at pre-determined intervals to determine the amount of water that was absorbed. The water uptake (in %) in 4, 11, 18, 28 and 32 days is described in Table 1 below and also shown in FIG. 1:

TABLE 1

| (in %) | 4 days | 11 days | 18 days | 28 days | 32 days |
|---|---|---|---|---|---|
| PA9 | 0.92 | 1.50 | 1.94 | 2.18 | 2.29 |
| PA12 | 0.82 | 1.04 | 1.35 | 1.55 | 1.65 |

These results demonstrate that PA9 can be used to effectively enhance the dimensional stability thanks to its low water uptake and high thermal stability.

1. An additive manufacturing method of making a three-dimensional (3D) object with a 3D printer equipped with a print head having an extrusion nozzle, the method comprising the following steps:
a filament comprising a polyamide composition (PC) is moved to the print head;
the polyamide composition (PC) in the molten form is deposited by the extrusion nozzle with a first layer on a substrate to form the beginning of a growing shaped object and with further layers on the growing shaped object, the layers being formed according to a predetermined sequence and pattern;
once the 3D object is prepared and has cooled, it is detached from the substrate,
wherein the polyamide composition (PC) consists of:
at least 50.0% wt % of at least one polyamide (PA) comprising at least 90.0 mol % of recurring unit R_{(PA1)} according to formula (V): 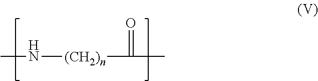
from 0 wt % to 50.0 wt % of at least one reinforcing agent, selected from the group consisting of mineral fillers, glass fibers, carbon fibers, synthetic polymeric fibers, aramid fibers, aluminum fibers, titanium fibers, magnesium fibers, boron carbide fibers, rock wool fibers, steel fibers, natural fibers, graphene, nano-graphene, carbon nanotube, wollastonite, glass balls and any combination of two or more thereof; and
from 0 wt % to 30.0 wt % of at least one additive, selected from the group consisting of lubricants, calcium stearate, magnesium stearate or sodium montanate; plasticizers; flame retardants; nucleating agents; heat stabilizers; light stabilizers; antioxidants; processing aids; fusing agents; electromagnetic absorbers; tougheners; antistatic agents; impact modifiers; anti-blocking additive; slip additives; antifogging additives; chemical blowing agents, and any combinations thereof;
wherein
n is 8 or 9;
wt % is relative to the total weight of the polyamide composition; and
mol % is relative to the total moles of recurring units in the polyamide (PA).

2. An additive manufacturing method of making a three-dimensional (3D) object, according to claim 1, comprising the steps of:
feeding an additive manufacturing filament comprising a polyamide composition (PC) to a discharge head member of a 3D printer, the discharge member having a through-bore ending with a discharge tip and a circumferential heater to melt the filament in the through-bore;
heating the filament within the discharge member while applying pressure to cause the discharge of the heated filament through the discharge tip onto a receiving platform or support structure; and
moving the discharge tip in X-, Y- and/or Z-direction(s) while the heated filament is being discharged to form the 3D object,
wherein the polyamide composition (PC) consists of:
at least 50.0 wt % of at least one polyamide (PA) comprising at least 90.0 mol % of recurring unit R_{(PA1)} according to formula (V): 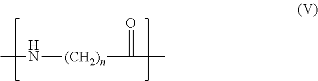
from 0 wt % to 50.0 wt % of at least one reinforcing agent, selected from the group consisting of mineral fillers, glass fibers, carbon fibers, synthetic polymeric fibers, aramid fibers, aluminum fibers, titanium fibers, magnesium fibers, boron carbide fibers, rock wool fibers, steel fibers, natural fibers, graphene, nano-graphene, carbon nanotube, wollastonite, glass balls and any combination of two or more thereof; and
from 0 wt % to 30.0 wt % of at least one additive, selected from the group consisting of lubricants, calcium stearate, magnesium stearate or sodium montanate; plasticizers; flame retardants; nucleating agents; heat stabilizers; light stabilizers; antioxidants; processing aids; fusing agents; electromagnetic absorbers; tougheners; antistatic agents; impact modifiers; anti-blocking additive; slip additives; antifogging additives; chemical blowing agents, and any combinations thereof;
wherein:
n is 8 or 9;
the polyamide (PA) does not comprise recurring units derived from a cyclic monomer;
wt % is relative to the total weight of the polyamide composition (PC); and
mol % is relative to the total moles of recurring units in the polyamide (PA).

3. (canceled)

4. (canceled)

5. (canceled)

6. (canceled)

7. (canceled)

8. (canceled)

9. The method according to claim 1, wherein the filament has a cylindrical or substantially cylindrical geometry and a diameter d between 0.5 mm and 5.0 mm.

10. (canceled)

11. (canceled)

12. The method according to claim 1, wherein the filament does not present a core/shell geometry.

13. The method according to claim 1, wherein the filament consists of the polyamide composition (PC).

14. The method according to claim 1, wherein the components of the polyamide composition (PC) are blended together.

15. (canceled)

16. (canceled)

17. (canceled)

18. (canceled)

19. (canceled)

20. (canceled)

21. The method according to claim 1, wherein the polyamide (PA) exhibits a biobased content of at least 85.0%, the biobased content being expressed as the % of organic carbon of renewable origin in the polyamide (PA) and measured according to ASTM D6866-22.

22. (canceled)

23. (canceled)

24. (canceled)

25. (canceled)

26. (canceled)

27. (canceled)

28. The method according to claim 1, wherein the reinforcing agent is selected from the group consisting of glass fibers, carbon fibers and combinations thereof.

29. A filament for use in 3D printing, having a diameter d between 0.5 mm and 5.0 mm, the composition of which consists of a polyamide composition (PC) consisting of:
at least 50.0 wt % of a polyamide (PA) comprising at least 90.0 mol % of recurring unit R_{(PA1)} according to formula (V): 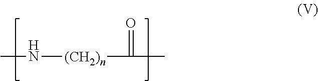
from 0 wt % to 50.0 wt % of at least one reinforcing agent, selected from the group consisting of mineral fillers, glass fibers, carbon fibers, synthetic polymeric fibers, aramid fibers, aluminum fibers, titanium fibers, magnesium fibers, boron carbide fibers, rock wool fibers, steel fibers, natural fibers, graphene, nano-graphene, carbon nanotube, wollastonite, glass balls and any combination of two or more thereof; and
from 0 wt % to 30.0 wt % of at least one additive, selected from the group consisting of lubricants, calcium stearate, magnesium stearate or sodium montanate; plasticizers; flame retardants; nucleating agents; heat stabilizers; light stabilizers; antioxidants; processing aids; fusing agents; electromagnetic absorbers; tougheners; antistatic agents; impact modifiers; anti-blocking additive; slip additives; antifogging additives; chemical blowing agents, and any combinations thereof,
wherein
n is 8 or 9;
the polyamide (PA) does not comprise recurring units derived from a cyclic monomer;
wt % is relative to the total weight of the polyamide composition (PC); and
mol % is relative to the total moles of recurring units in the polyamide (PA).

30. The Filament according to claim 29, having a cylindrical or substantially cylindrical geometry.

31. (canceled)

32. The Filament according to claim 29, wherein the filament does not present a core/shell geometry.

33. The Filament according to claim 29, wherein the components of the polyamide composition (PC) are blended together.

34. (canceled)

35. (canceled)

36. (canceled)

37. The Filament according to claim 29, wherein the polyamide (PA) exhibits a biobased content of at least 85.0%, the biobased content being expressed as the % of organic carbon of renewable origin in the polyamide (PA) and measured according to ASTM D6866-22.

38. (canceled)

39. (canceled)

40. (canceled)

41. (canceled)

42. (canceled)

43. (canceled)

44. (canceled)

45. A spool comprising the filament of claim 29.

46. A method for the preparation of a 3D object by additive manufacturing comprising extruding the filament according to claim 29.

47. (canceled)

48. (canceled)

49. (canceled)
